(19) United States
(12) Patent Application Publication
(10) Pub. No.: US 2026/0172683 A1
(43) Pub. Date: Jun. 18, 2026

(54) SEMICONDUCTOR DEVICE AND CAMERA SYSTEM

(71) Applicant: Renesas Electronics Corporation, Tokyo (JP)

(72) Inventors: Wataru SAITO, Tokyo (JP); Fukashi MORISHITA, Tokyo (JP)

(21) Appl. No.: 19/410,177

(22) Filed: Dec. 5, 2025

(30) Foreign Application Priority Data
Dec. 17, 2024 (JP) 2024-220835

(51) Int. Cl. H04N 23/68; H04N 25/772; H04N 25/78

(52) U.S. Cl. CPC H04N 23/687; H04N 23/684; H04N 25/772; H04N 25/78

(57) ABSTRACT

A semiconductor device includes: a hole amplifier circuit; and an input terminal to which a sensor control signal generated in a period in which an image acquiring operation by an image sensor is not performed is input. In the hole amplifier circuit, a differential amplifier includes differential input nodes for input of a hole voltage from a hole sensor. One end of a plurality of capacitors is connected to the differential input nodes to determine a gain of the hole amplifier circuit. A refresh circuit causes the differential input nodes to retain correction voltages for canceling an offset voltage in accordance with a refresh signal synchronizing with a sensor control signal.

### CROSS-REFERENCE TO RELATED APPLICATIONS

The present application claims priority from Japanese Patent Application No. 2024-220835 filed on Dec. 17, 2024, the content of which is hereby incorporated by reference to this application.

### BACKGROUND

The present invention relates to a semiconductor device and a camera system including the semiconductor device.

There is disclosed technique listed below.

[Patent Document 1] Japanese Unexamined Patent Application Publication No. 2024-73944

The Patent Document 1 discloses a variable gain amplifier capable of performing calibration in accordance with an offset voltage and of suppressing an influence of noise of an ADC. The variable gain amplifier includes a full differential amplifier for amplifying a differential input voltage having the offset voltage. To each of a non-inverting input node and an inverting input node of the full differential amplifier, a correction voltage is applied via a resistance element from a digital-to-analog converter.

### SUMMARY

For example, a camera system mounting an image-shake correction (anti-shake) function called Optical Image Stabilization (OIS) has been known. The camera system performs, for example, image-shake correction by moving an OIS lens so as to cancel the image shake. For moving the OIS lens, for example, a hole element for detecting a position of the OIS lens is required. A differential detection signal from the hole element is amplified by the differential amplifier, and is then used for controlling the position of the OIS lens. However, the differential detection signal from the hole element usually includes an offset voltage.

Therefore, in order to cancel such an offset voltage, for example, as disclosed in the Patent Document 1, a method of using the digital-to-analog converter to apply a correction voltage to the differential amplifier is thought. However, the digital-to-analog converter usually requires a large circuit area. As a result, a semiconductor device mounting the digital-to-analog converter and the differential amplifier can be also increased in size. Particularly, in a small-size camera system represented by a smartphone, it is not preferable to increase the size of the semiconductor device.

Embodiments described later have been made in consideration of the above, and other problems and novel characteristics will be apparent from the description of the present specification and the accompanying drawings.

A semiconductor device according to one embodiment includes: an amplifier circuit amplifying a differential detection signal from a predetermined sensor to have a predetermined gain; and a first input terminal to which a sensor control signal generated in a period in which an image acquiring operation by an image sensor is not performed is input. The amplifier circuit includes a differential amplifier, a plurality of capacitors, and a refresh circuit. The differential amplifier includes a differential input node for input of the differential detection signal. One end of the plurality of capacitors is connected to the differential input node to determine the predetermined gain in the amplifier circuit. The refresh circuit synchronizes with the sensor control signal, and causes the differential input node to retain a correction voltage for canceling an offset voltage included in the differential detection signal.

According to the above embodiment, the semiconductor device can be downsized.

### BRIEF DESCRIPTION OF THE DRAWINGS

FIG. 1 is an outline diagram showing a configuration example of a camera system according to a first embodiment.

FIG. 2A is an outline diagram showing a configuration example of a principal part of an image sensor of FIG. 1.

FIG. 2B is a circuit diagram showing a configuration example of a pixel circuit of FIG. 2A.

FIG. 3 is a circuit diagram showing a configuration example of a hole amplifier circuit shown in FIG. 1, in a semiconductor device according to the first embodiment.

FIG. 4 is a timing chart showing one example of an operation sequence in the camera system shown in FIG. 1 and FIG. 3.

FIG. 5 is a circuit diagram showing a configuration example of a hole amplifier circuit while including details of a refresh circuit in FIG. 3.

FIG. 6 is a schematic diagram showing an operation example of the hole amplifier circuit of FIG. 5.

FIG. 7 is a circuit diagram showing a configuration example of the hole amplifier circuit while including the details of the refresh circuit shown in FIG. 3, in a semiconductor device according to a second embodiment.

FIG. 8 is a timing chart showing one example of an operation sequence of a camera system shown in FIG. 1 and FIG. 7.

FIG. 9 is a circuit diagram showing a configuration example of a hole amplifier circuit modified from that of FIG. 5, in a semiconductor device according to a third embodiment.

FIG. 10 is a circuit diagram showing a configuration example of a hole amplifier circuit modified from that of FIG. 7 in the semiconductor device according to the third embodiment.

FIG. 11 is a circuit diagram showing a configuration example of the hole amplifier circuit shown in FIG. 1, in a semiconductor device according to a fourth embodiment.

FIG. 12 is a schematic diagram showing an operation example of an offset cancellation circuit of FIG. 11.

FIG. 13 is a circuit diagram showing a configuration example of a hole amplifier circuit according to a comparative example.

FIG. 14 is a diagram showing one example of characteristics of a hole sensor of FIG. 13.

FIG. 15 is a timing chart showing one example of an operation sequence of a camera system according to a comparative example.

### DETAILED DESCRIPTION

In the embodiments described below, the invention will be described in a plurality of sections or embodiments when required as a matter of convenience. However, these sections or embodiments are not irrelevant to each other unless otherwise stated, and the one relates to the entire or a part of the other as a modification example, details, or a supplementary explanation thereof. Also, when referring to the number of elements (including number of pieces, values, amount, range, and the like), the number of the elements is not limited to a specific number unless otherwise stated or except the case where the number is apparently limited to a specific number in principle. That is, the number of the elements and the like may be the number larger or smaller than the specified number.

Further, in the embodiments described below, it goes without saying that the components (including element steps) are not always indispensable unless otherwise stated or except the case where the components are apparently indispensable in principle. Similarly, when the shape of the components, positional relation thereof, and the like are mentioned, the substantially approximate and similar shapes and the like are included therein unless otherwise stated or except the case where it is conceivable that they are apparently excluded in principle. The same goes for the numerical value and the range described above.

Note that the same components are denoted by the same reference symbols throughout all the drawings for describing the embodiments, and the repetitive description thereof will be omitted.

### First Embodiment

### Outline of Camera System

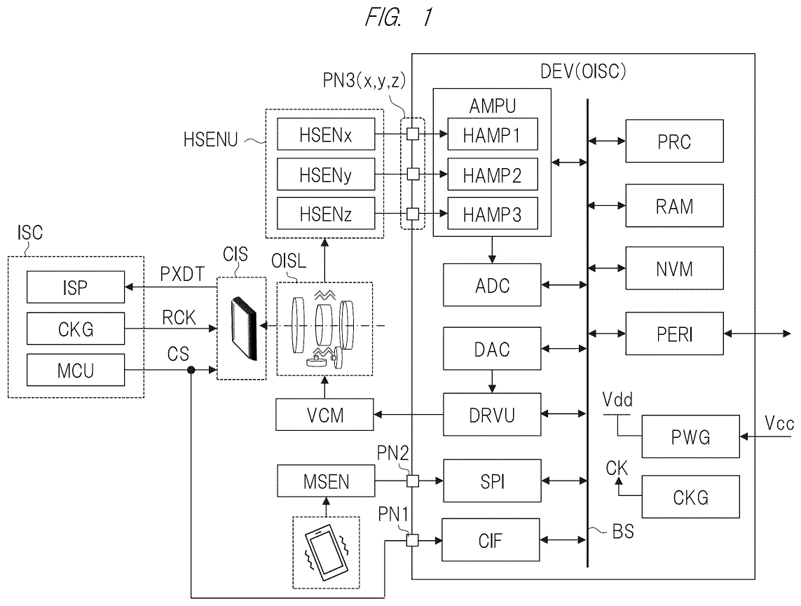

FIG. 1 is an outline diagram showing a configuration example of a camera system according to a first embodiment. A camera system shown in FIG. 1 includes an image sensor CIS, an OIS lens OISL, a voice coil motor VCM, and an image sensor controller ISC. Further, the camera system includes a hole sensor unit HSENU, a motion sensor MSEN, and a semiconductor device DEV. The camera system is mounted as a camera module in one housing, as represented by, for example, a smartphone.

The image sensor CIS is, for example, a complementary metal oxide semiconductor (CMOS) image sensor. However, the image sensor CIS may be a charge coupled device (CCD) image sensor. In the OIS lens OISL, light from a light source is collected on the image sensor CIS. The OIS lens OISL is movably installed with respect to the image sensor CIS. The voice coil motor VCM is one example of an actuator for moving the OIS lens OISL. The voice coil motor VCM moves a position of the OIS lens OISL in an X-axis direction, a Y-axis direction, or a Z-axis direction, based on an input drive signal.

The image sensor controller ISC includes, for example, an image signal processor ISP, a clock generation circuit CKG, a microcontroller unit MCU, and the like. The clock generation circuit CKG supplies an operation reference clock signal RCK to the image sensor CIS. The microcontroller unit MCU includes a processor, a memory, and the like, and uses a sensor control signal CS to control the image sensor CIS. The image signal processor ISP performs various image processings to digital pixel data PXDT output from the image sensor CIS. As a content of the image processing, for example, a demosaic processing, a contrast adjustment processing, and the like are exemplified.

The hole sensor unit HSENU includes, for example, three hole sensors HSENx, HSENy, HSENz. In the specification, the three hole sensors HSENx, HSENy, HSENz are called a hole sensor HSEN as a generic term. The hole sensor HSEN is one example of a position sensor for detecting the position of the OIS lens OISL. The three hole sensors HSENx, HSENy, HSENz detect an X-axis position, a Y-axis position, and a Z-axis position of the OIS lens OISL, respectively. The motion sensor MSEN is, for example, a gyroscope sensor. The motion sensor MSEN detects motion of the housing represented by a smartphone. That is, the motion sensor MSEN detects an image-shake amount.

The semiconductor device DEV is, for example, a system on chip (SoC) made of one semiconductor chip, a microcontroller unit, or the like. In this example, the semiconductor device DEV is also an OIS controller OISC for controlling the voice coil motor VCM and, by extension, the OIS lens OISL. The semiconductor device DEV includes five input terminals PN1, PN2, PN3x, PN3y, PN3z. In addition, the semiconductor device DEV also includes an internal unit connected thereto by a bus BUS. Further, the semiconductor device DEV also includes a power supply circuit PWG, a clock generation circuit CKG, and the like.

To the input terminal (first input terminal) PN1, the sensor control signal CS from the image sensor controller ISC, in detail, from the microcontroller unit MCU, is input. To the input terminal (second input terminal) PN2, a detection signal from the motion sensor MSEN is input. To the three input terminals PN3x, PN3y, PN3z, the differential detection signals, that is, the hole voltage from the three hole sensors HSENx, HSENy, HSENz, are input, respectively.

To the power supply circuit PWG, an external power supply voltage Vcc is input, and the power supply circuit PWG generates an internal power supply voltage Vdd used in the semiconductor device DEV. The clock generation circuit CKG uses a phase locked loop (PLL) circuit and the like to generate an internal clock signal CK used in the semiconductor device DEV. An internal unit connected by the bus BS includes a processor PRC, a volatile memory RAM, and a non-volatile memory NVM. In addition, the internal unit includes an amplifier circuit unit AMPU, an analog-to-digital converter ADC, the digital-to-analog converter DAC, and a driver unit DRVU. Further, the internal unit includes a serial parallel interface SPI, a control input interface CIF, and the other peripheral circuit PERI.

The volatile memory RAM is, for example, a static random access memory (SRAM) or the like. The non-volatile memory NVM is, for example, a flush memory or the like. The processor PRC includes a central processing unit (CPU). Further, the processor PRC can also include a digital signal processor (DSP), a graphics processing unit (GPU), and the like. The processor PRC executes a predetermined program, here, an OIS control program, copied from the non-volatile memory NVM to the volatile memory RAM.

The serial parallel interface SPI converts the detection signal input at the input terminal PN2 from the motion sensor MSEN, into a parallel signal. The serial parallel interface SPI outputs a parallel signal indicating a detection result of the motion sensor MSEN, to the processor PRC via the bus BS. Meanwhile, the amplifier circuit unit AMPU includes three hole amplifier circuits HAMP1, HAMP2, HAMP3. In the specification, the three hole amplifier circuits HAMP1 to HAMP3 are called a hole amplifier circuit HAMP as a generic term.

The three hole amplifier circuits HAMP1 to HAMP3 amplify the differential detection signal input from the hole sensor unit HSENU via the three input terminals PN3x to PN3z, respectively, to have a predetermined gain. The analog-to-digital converter ADC converts an output voltage of the hole amplifier circuit HAMP into a digital value. The analog-to-digital converter ADC outputs the digital value, that is, the detection result of the hole sensor HSEN to the processor PRC via the bus BS.

Here, the processor PRC calculates an operation amount in moving the position of the OIS lens OISL, based on the detection result of the motion sensor MSEN and the detection result of the hole sensor HSEN. As a specific example, the processor PRC calculates a target shift amount of the OIS lens OISL for canceling the image-shake amount, based on the detection result of the motion sensor MSEN. In addition, the processor PRC recognizes a shift amount of the OIS lens OISL, based on the detection result of the hole sensor HSEN. Then, the processor PRC calculates the operation amount required for matching the shift amount of the OIS lens OISL with the target shift amount, by using, for example, proportional integral differential (PID) control.

The processor PRC outputs the calculated operation amount to the digital-to-analog converter DAC via the bus BS. The digital-to-analog converter DAC converts the input operation amount, that is, the digital value into an analog value. The driver unit DRVU generates, for example, a drive signal proportional to the analog value. Alternatively, the processor PRC may output the calculated operation amount to the driver unit DRVU via the bus BS. Then, as the drive signal, the driver unit DRVU may generate a pulse width modulation (PWM) signal having a duty ratio in accordance with the input operation amount.

The driver unit DRVU outputs the generated drive signal to the voice coil motor VCM. The voice coil motor VCM moves the position of the OIS lens OISL, based on the input drive signal. Consequently, the image-shake correction can be achieved. That is, a position of a focus of the light from the same light source on the image sensor CIS can be maintained, regardless of the image-shake. Note that details of the input terminal PN1 and the control input interface CIF will be described later.

### Outline of Image Sensor

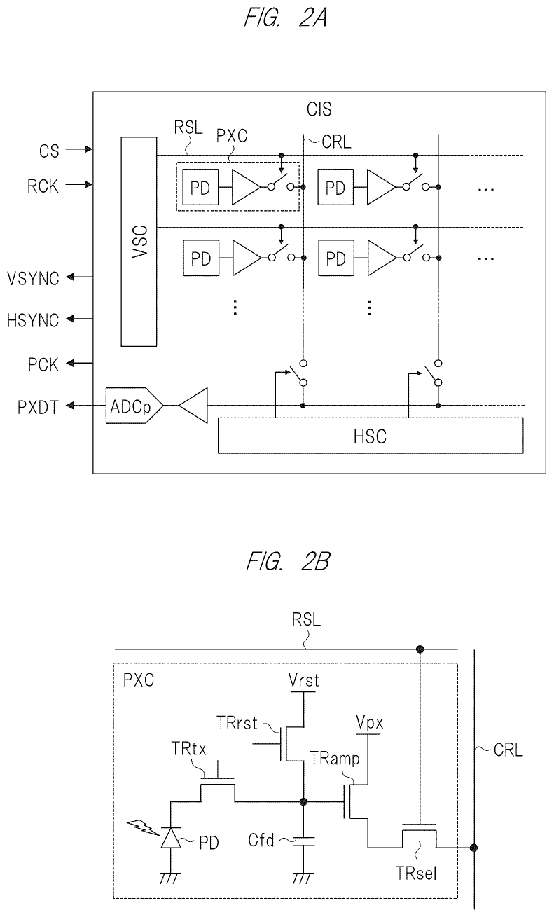

FIG. 2A is an outline diagram showing a configuration example of a principal part of the image sensor CIS of FIG. 1. FIG. 2B is a circuit diagram showing a configuration example of a pixel circuit PXC of FIG. 2A. The image sensor CIS shown in FIG. 2A includes a plurality of row selection lines RSL, a plurality of column read lines CRL, and a plurality of pixel circuits PXC. The plurality of pixel circuits PXC are arranged at intersections between the plurality of row selection lines RSL and the plurality of column read lines CRL.

Further, the image sensor CIS also includes a vertical scan circuit VSC, a horizontal scan circuit HSC, an analog-to-digital converter ADCp, a not-illustrated timing generation circuit, and the like. The vertical scan circuit VSC performs scan on the plurality of row selection lines RSL. The horizontal scan circuit HSC performs scan on the plurality of column read lines CRL.

To the image sensor CIS, a sensor control signal CS from the microcontroller unit MUCU and a reference clock signal RCK from the clock generation circuit CKG are input. The image sensor CIS uses the timing generation circuit to generate various timing signals synchronizing with the reference clock signal RCK, and operates based on the timing signals. Schematically, the image sensor CIS sequentially performs, for example, a resetting operation and an image acquiring operation, in other words, a light-exposing operation in accordance with a start command based on the sensor control signal CS. Further, the image sensor CIS also performs an image outputting operation that outputs digital pixel data PXDT acquired by the image acquiring operation, to an image signal processor ISP.

Each of the plurality of pixel circuits PXC includes a photodiode PD, a transfer transistor TRtx, and a capacitor Gfd as shown in FIG. 2B. Further, the pixel circuit PXC includes a resetting transistor TRrst, an amplifier transistor TRamp, and a selection transistor TRsel. Firstly, in the resetting operation, the pixel circuit PXC controls the resetting transistor TRrst in the on-state for a predetermined time. Consequently, the pixel circuit PXC resets the pixel signal accumulated in the capacitor Cfd by a resetting power supply voltage Vrst.

Subsequently, in the image acquiring operation, the pixel circuit PXC controls the transfer transistor TRtx in the on-state. Consequently, to the capacitor Cfd, the pixel circuit PXC transfers the pixel signal obtained from, that is, exposed by a photodiode PD. In the pixel circuit PXC, the pixel signal transferred to the capacitor Cfd is amplified by the amplifier transistor TRamp, and is read out to the column read line CRL via the selection transistor TRsel.

The image sensor CIS shown in FIG. 2A uses the analog-to-digital converter ADCp to convert the pixel signal read out to the column read line CRL as described above, into the digital pixel data PXDT. Then, in the image outputting operation, the image sensor CIS outputs the digital pixel data PXDT to the image signal processor ISP. At this time, the image sensor CIS also outputs, for example, a vertical synchronization signal VSYNC, a horizontal synchronization signal HSYNC, a pixel clock signal PCK, and the like together.

The vertical synchronization signal VSYNC is a signal indicating a start time point and an end time point in outputting the digital pixel data PXDT in units of one frame. The horizontal synchronization signal HSYNC is a signal indicating a start time point and an end time point in outputting the digital pixel data PXDT in units of row in one frame. The pixel clock signal PCK is a signal indicating an output time point in outputting the digital pixel data PXDT in units of pixel in one row.

In such an operation, a period required for an operation of the hole amplifier circuit HAMP in view of the above-described image-shake correction is an image acquisition period in which the image acquiring operation is performed, in other words, a light-exposure period. The image acquisition period that is the period required for the operation of the hole amplifier circuit HAMP occurs, for example, not continuously but intermittently even in the video capturing. In the specification, a period excluding the image acquisition period, that is, a period in which the image acquiring operation by the image sensor CIS is not performed is called a blanking period.

The sensor control signal CS from the microcontroller unit MCU is a signal generated and output in this blanking period. A specific content of the sensor control signal CS may vary depending on specifications of the image sensor CIS. A specific example of the sensor control signal CS is, for example, a start trigger signal for instructing the image sensor CIS to start the image capturing. In addition, another specific examples are various setting signals for giving various setting values to or instructing the image sensor CIS to change setting values. In this case, for communication of the various setting signals, for example, an inter-integrated circuit (I2C) interface is used.

### About Hole Amplifier Circuit (Comparative Example) and its Problems

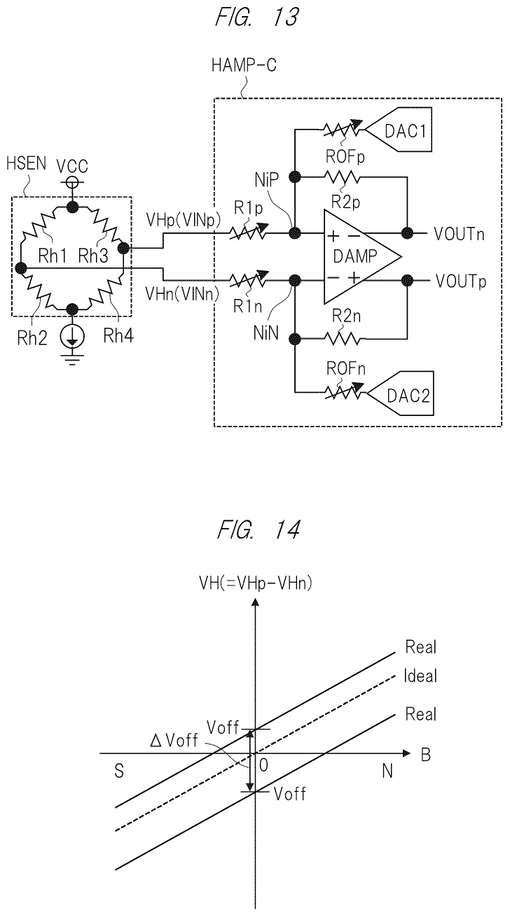

FIG. 13 is a circuit diagram showing a configuration example of a hole amplifier circuit HAMP-C according to a comparative example. FIG. 13 shows an equivalent circuit of the hole sensor HSEN, in other words, the hole element in addition to a configuration example of the hole amplifier circuit HAMP-C. FIG. 14 is a diagram showing one example of characteristics of the hole sensor HSEN of FIG. 13. FIG. 14 shows characteristics of a hole voltage VH changing in accordance with a magnetic field B.

As shown in FIG. 13, the equivalent circuit of the hole sensor HSEN, that is, the hole element is indicated by a bridge circuit made of four resistance elements Rh1 to Rh4. When the power supply voltage VCC is applied to the bridge circuit, the bride circuit outputs a positive-side hole voltage VHp and a negative-side hole voltage VHn as the differential detection signals. The final hole voltage VH is obtained by a differential voltage “VHp−VHn” between the positive-side hole voltage VHp and the negative-side hole voltage VHn. All resistance values of the four resistance elements Rh1 to Rh4 are ideally the same value. In this case, the hole voltage VH is zero [V] in a state in which the magnetic field B is zero. That is, no offset voltage occurs in the hole voltage VH.

However, practically, the resistance values of the four resistance elements Rh1 to Rh4 can differ from one another in accordance with variation in the manufacturing and variation in the temperature characteristics of the hole elements and the like. In this case, as shown in FIG. 14, the hole voltage VH can be made non-zero [V] even though the magnetic field B is in a state of zero. That is, the offset voltage Voff occurs in the hole voltage VH. A value of the offset voltage Voff can be made a positive value or a negative value for each hole element. In this way, if there is variation ΔVoff in the offset voltage Voff for each hole element, detection accuracy of the lens position, by extension, accuracy of the image-shake correction decrease in the semiconductor device DEV shown in FIG. 1.

Therefore, it is conceivable to use the hole amplifier circuit HANP-C as shown in FIG. 13. The hole amplifier circuit HAMP-C includes a differential-output type differential amplifier DAMP, that is, a full differential amplifier, and four resistance elements R1p, R2p, R1n, R2n. The four resistance elements R1p, R2p, R1n, R2n determine a gain of the differential amplifier DAMP. Here, when the offset voltage Voff is included in the hole voltage VH, the differential amplifier DAMP performs the amplifying operation while including the offset voltage Voff that is a DC component. This case may cause a situation in which the differential output voltage VOUT (=VOUTp−VOUTn) from the differential amplifier DAMP is not within an output range in addition to the decrease in the accuracy of the image-shake correction.

Therefore, the hole amplifier circuit HAMP-C further includes two variable resistance elements ROFp and ROFn and two digital-to-analog converters DAC1 and DAC2. The digital-to-analog converter DAC1 applies the predetermined correction voltage to the non-inverting-side differential input node NiP in the differential amplifier DAMP via the variable resistance element ROFp. Similarly, the digital-to-analog converter DAC2 applies the predetermined correction voltage to the inverting-side differential input node NiN in the differential amplifier DAMP via the variable resistance element ROFn. By applying those correction voltages, the offset voltage Voff included in the hole voltage VH can be canceled, and besides, the offset voltage occurring in the differential amplifier DAMP itself can be also canceled.

However, the case of the use of the hole amplifier circuit HAMP-C according to the comparative example causes two main problems. A first problem is that a circuit area of the semiconductor device DEV is increased by providing the two digital-to-analog converters DAC1 and DAC2. That is, the digital-to-analog converter generally requires a large circuit area. Meanwhile, particularly in a camera system such as a smartphone, it is required to decrease the size of the semiconductor device DEV. A second problem is that a start-up test for determining the optimum correction voltage is required in starting up the hole amplifier circuit HAMP-C. There is a risk of influence of time required for the start-up test on, for example, a start-up time of the camera system.

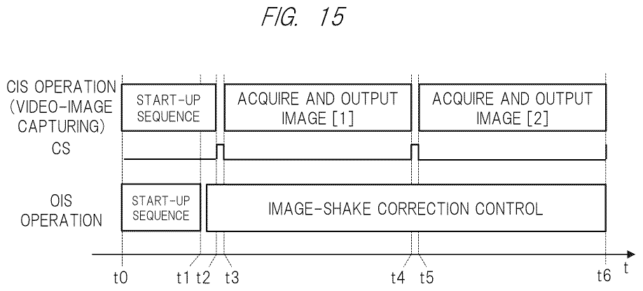

FIG. 15 is a timing chart showing one example of an operation sequence of a camera system according to a comparative example. The camera system according to the comparative example includes the semiconductor device according to the same comparative example as that of the case of FIG. 1, that is, the OIS controller. A configuration shown in FIG. 13 is applied to three hole amplifier circuits HAMP1 to HAMP3 in the OIS controller. However, the OIS controller according to the comparative example does not include the input terminal PIN and the control input interface CIF to which the sensor control signal CS is input from the image sensor controller ISC.

In FIG. 15, the image sensor CIS and the OIS controller according to the comparative example start a start-up sequence at time t0. The OIS controller performs the start-up test for determining the above-described optimum correction voltage in the start-up sequence. At the start-up test, the OIS controller firstly sets initial values for the two digital-to-analog converters DAC1 and DAC2 and the two variable resistance elements ROFp and ROFn. In this state, the OIS controller acquires, for example, the respective hole voltages VH acquired when the OIS lens OISL is moved to a positive-side limit position and to a negative-side limit position.

Then, the OIS controller refers to two digital values output from the analog-to-digital converter ADC and corresponding to the two hole voltages VH. The OIS controller calculates the correction voltage required for matching a center position based on those two digital values with a center position of the output range of the analog-to-digital converter ADC. The OIS controller sets the digital value based on its calculated result to, for example, one of the two digital-to-analog converter DAC1 and DAC2. When the start-up sequence ends at time t1, the OIS controller thereafter continuously performs control of the image-shake correction as described above.

Meanwhile, the image sensor CIS ends the start-up sequence at time t2. In accordance with this, the image sensor controller ISC, more specifically, the microcontroller unit MCU outputs the sensor control signal CS to the image sensor CIS in a period of time t2 to t3. The image sensor CIS performs the image acquiring operation and the image outputting operation in a period of time t3 to t4 in accordance with the sensor control signal CS. In this case, the control of the image-shake correction by the OIS controller is also performed in parallel.

In addition, here, as an example of a case of the motion-image capturing, the microcontroller unit MCU outputs the sensor control signal CS to the image sensor CIS in a period of time t4 to t5. In accordance with this, the image sensor CIS performs a second image acquiring operation and a second image outputting operation. After this, the control of the image-shake correction by the OIS controller is similarly continuously performed, while the image sensor CIS sequentially performs the image acquiring operation and the image outputting operation. In this way, in the camera system according to the comparative example, the image sensor CIS and the image sensor controller ISC operate in asynchronous with the OIS controller.

Here, as an example, FIG. 15 shows a case in which a time required for the start-up sequence of the OIS controller is shorter than a time required for the start-up sequence of the image sensor CIS. However, when a magnitude relationship in the time is opposite, for example, the image sensor CIS needs to wait for the end of the start-up sequence of the OIS controller and then perform the first image acquiring operation. That is, the image sensor CIS needs to perform the first image acquiring operation in a state in which the control of the image-shake correction is effective. This case causes a risk of increase in the start-up time of the camera system.

### About Hole Amplifier Circuit (Embodiment)

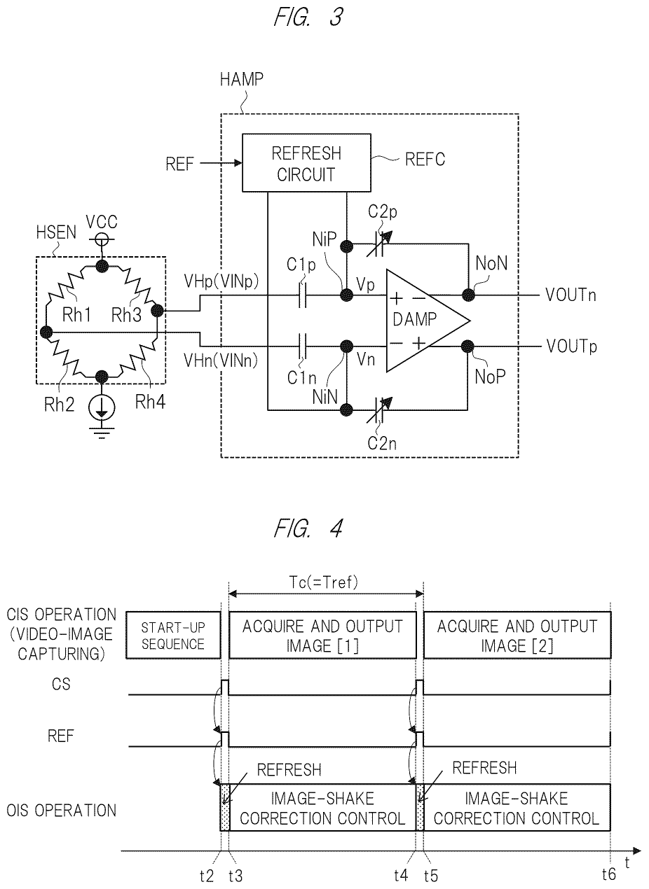

FIG. 3 is a circuit diagram showing a configuration example of the hole amplifier circuit HAMP shown in FIG. 1 in the semiconductor device according to the first embodiment. The hole amplifier circuit HAMP shown in FIG. 3 includes the differential amplifier DAMP, the four capacitors C1p, C2p, C1n, C2n, and the refresh circuit REFC. The differential amplifier DAMP is, here, the full differential amplifier including differential output nodes NoN, NoP in addition to the differential input nodes NiP, NiN. The differential input nodes NiP, NiN are made of the non-inverting-side differential input node NiP and the inverting-side differential input node NiN. The differential output nodes NoN, NoP are made of the inverting-side differential output node NoN and the non-inverting-side differential output node NoP.

One ends of the two capacitors C1p, C2p are connected to the non-inverting-side differential input node NiP. To the other end of the capacitor C1p, the positive-side hole voltage VHp is applied as a positive-side differential input voltage VINp. The other end of the capacitor C2p is connected to the inverting-side differential output node NoN. Similarly, one ends of the two capacitors C1n, C2n are connected to the inverting-side differential input node NiN. To the other end of the capacitor C1n, the negative-side hole voltage VHn is applied as a negative-side differential input voltage VINn. The other end of the capacitor C2n is connected to the non-inverting-side differential output node NoP.

The four capacitors C1p, C2p, C1n, C2n determine the gain of the hole amplifier circuit HAMP. Specifically, the two capacitors C1p, C1n among the four capacitors are set at the same capacity value “C1”. The remaining two capacitors C2p, C2n are also set at the same capacity value “C2”. In this case, the hole amplifier circuit HAMP amplifies the hole voltage VH that is the differential detection signals from the hole sensor HSEN, to have a gain “C1/C2”. Then, the hole amplifier circuit HAMP outputs the amplified differential output voltages VOUTn, VOUTp to the differential output nodes NoN, NoP. Note that the two capacitors C2p, C2n are specifically made of a variable capacitor to achieve a variable gain.

In this way, by using the capacitor type hole amplifier circuit HAMP, the digital-to-analog converters DAC1, DAC2 as shown in FIG. 13 can be made unnecessary. As a result, the circuit area of the hole amplifier circuit HAMP can be decreased, and the semiconductor device DEV can be downsized and reduced in cost. More specifically, the differential input nodes NiP, NiN can retain the correction voltages Vp, Vn because of the four capacitors C1p, C2p, C1n, C2n. The correction voltages Vp, Vn are voltages for canceling the offset voltage Voff included in the hole voltage VH. Consequently, the hole amplifier circuit HAMP can amplify the input hole voltage VH in a state in which the offset voltage Voff is canceled.

However, the correction voltages Vp, Vn retained at the differential input nodes NiP, NiN can be changed with time by discharge of the four capacitors C1p, C2p, C1n, C2n. Therefore, the refresh circuit REFC is provided. The refresh circuit REFC refreshes the correction voltages Vp, Vn in accordance with, for example, the regularly-input refresh signal REF. The refresh signal REF is a signal synchronizing with the sensor control signal CS from the microcontroller unit MCU as described later. Therefore, the refresh circuit REFC synchronizes with the sensor control signal CS, and causes the differential input nodes NiP, NiN to retain the correction voltages Vp, Vn used for canceling the offset voltage Voff.

FIG. 4 is a timing chart showing one example of an operation sequence in the camera system shown in FIG. 1 and FIG. 3. FIG. 4 is different from a case of FIG. 15 in the following three points. A first different point is that the refresh signal REF generated in synchronization with the sensor control signal CS is added. More specifically, in FIG. 1, the sensor control signal CS is input to the control input interface CIF via the input terminal (first input terminal) PN1. The control input interface CIF is made of, for example, the same specifications as those of the input interface of the sensor control signal CS included in the image sensor CIS. As one example, the control input interface CIF may be the I2C interface.

The control input interface CIF generates, for example, the refresh signal REF asserted in a fixed period in accordance with the sensor control signal CS. The fixed period may be, for example, much shorter than about 1 [ms]. The control input interface CIF outputs the generated refresh signal REF to the hole amplifier circuit HAMP via the bus BS. The hole amplifier circuit HAMP refreshes the correction voltages Vp, Vn in an assertion period of this refresh signal REF. Note that the sensor control signal CS can be also used as it is for the refresh signal REF, depending on a type of the sensor control signal CS.

A second different point is that the OIS controller OISC operates not continuously but intermittently because of the first different point. That is, the OIS controller OISC does not perform the control of the image-shake correction in a period of time t2 to t3 in which the hole amplifier circuit HAMP performs the refreshing operation and a period of time t4 to t5. On the other hand, the OIS controller OISC performs the control of the image-shake correction in a period of time t3 to t4 in which the image acquiring operation is performed and a period of time t5 to t6.

More specifically, for example, in the period of time t4 to t5, the OIS controller OISC controls, for example, the position of the OIS lens OISL provided at time t4 so as to maintain the position as it is. As a specific example, the processor PRC may retain respective detection results of the hole sensor HSEN and the motion sensor MSEN as they are, at a time point at which the refresh signal REF is asserted. Then, the processor PRC may perform, for example, a calculation processing of the operation amount in a state in which the respective detection results provided at time t4 are retained until time t5.

A third different point is that the start-up sequence by the OIS controller OISC shown in FIG. 15 also becomes unnecessary because the digital-to-analog converters DAC1, DAC2 become unnecessary. As a result, the time required for the start-up of the camara system may be reduced. In addition, power consumption required for the start-up sequence can be also reduced.

### Details of Refresh Circuit

FIG. 5 is a circuit diagram showing a configuration example of a hole amplifier circuit HAPa while including details of the refresh circuit REFC in FIG. 3. The refresh circuit REFC shown in FIG. 5 is made of two switches SWp, SWn for short-circuit between the differential output nodes NoN, NoP and the differential input nodes NiP, NiN. The switch SWp causes short-circuit between the inverting-side differential output node NoN and the non-inverting-side differential input node NiP. The switch SWn causes short-circuit between the non-inverting-side differential output node NoP and the inverting-side differential input node NiN.

On-states and off states of both of the two switches (first refresh switches) SWp, SWn, are controlled in accordance with the refresh signal REF. More specifically, the two switches SWp, SWn are controlled to be in the on-states in an assertion period of the refresh signal REF, and are controlled to be in the off-states in a negation period thereof. Note that each of the two switches SWp, SWn can be made of, for example, a CMOS switch.

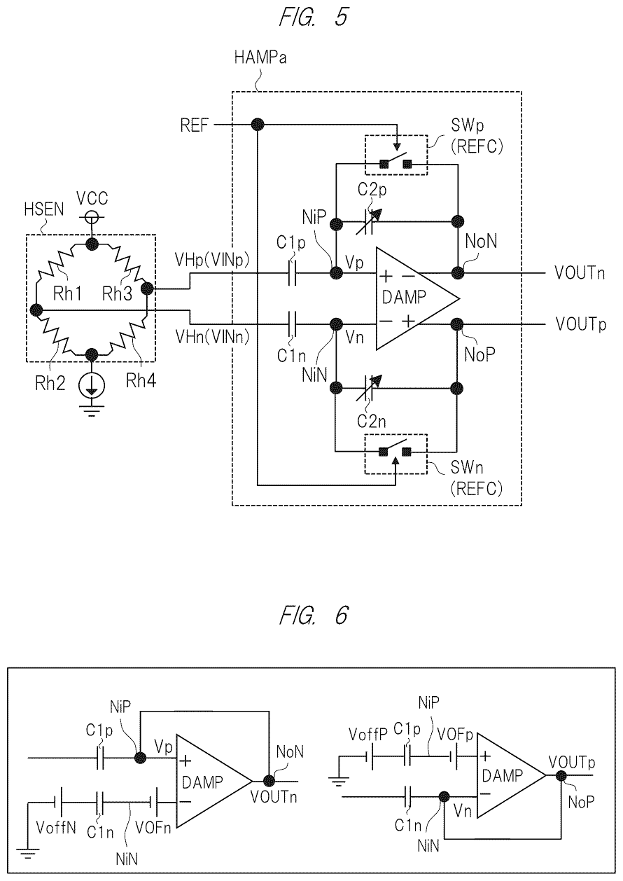

FIG. 6 is a schematic diagram showing an operation example of the hole amplifier circuit HAMPa of FIG. 5. The hole amplifier circuit HAMPa causes the short-circuit between the differential input nodes NiP, NiN and the differential output nodes NoN, NoP in the refresh period. Consequently, as shown in FIG. 6, the hole amplifier circuit HAMPa functions as a unity gain amplifier.

Here, to the inverting-side differential input node NiN, two offset voltages VoffN, VOFn have been applied. The offset voltage VoffN is a voltage included in the negative-side hole voltage VHn. The offset voltage VOFn is a voltage equivalently occurring in the differential amplifier DAMP itself. Similarly, to the non-inverting-side differential input node NiP, two offset voltages VoffP, VOFp have been applied. The offset voltage VoffP is a voltage included in the positive-side hole voltage VHp. The offset voltage VOFp is a voltage equivalently occurring in the differential amplifier DAMP itself.

In this case, by an operation of the unity gain amplifier, a voltage equal to the voltage applied to the inverting-side differential input node NiN is applied to the non-inverting-side differential input node NiP. That is, to the non-inverting-side differential input node NiP, a voltage equal to an added value of the two offset voltages VoffN, VOFn is applied. Similarly, to the inverting-side differential input node NiN, a voltage equal to the voltage applied to the non-inverting-side differential input node NiP is applied. That is, to the non-inverting-side differential input node NiN, a voltage equal to an added value of the two offset voltages VoffP, VOFp is applied. The hole amplifier circuit HAMPa transitions to a normal period after passing this refresh period.

In the normal period, the two switches SWp, SWn are controlled to be in the off-states. In this case, the non-inverting-side differential input node NiP retains the voltage “VoffN+VOFn” applied in the refresh period, as the correction voltage Vp by using the capacitors C1p, C2p. Similarly, the inverting-side differential input node NiN retains the voltage “VoffP+VOFp” applied in the refresh period, as the correction voltage Vn by using the capacitors C1n, C2n. Then, under this state, the hole amplifier circuit HAMPa amplifies the input hole voltage VH. As a result, the offset voltages VoffP, VoffN included in the hole voltage VH and the offset voltages VOFp, VOFn occurring in the differential amplifier DAMP itself can be canceled together.

Note that a cycle Tc of the image acquiring operation in FIG. 4 described above is, for example, 33 [ms] when the video-image capturing is performed at a low rate such as 30 [fps]. Practically, a rate higher than 30 [fps] is often used, and the cycle Ts can be made shorter than 33 [ms]. Meanwhile, in the configuration example shown in FIG. 5, the discharge because of the capacitors C1p, C2p, C1n, C2n can occur as described in FIG. 3 in the control period of the image-shake correction. In addition to this, a leak current via the switches SWp, SWn that are in the off-states can also occur.

In this case, it is desirable that a cycle Tref of the refreshing operation is, for example, about 100 [ms] or less in order to maintain the correction voltages Vp, Vn with some degree of high accuracy. This condition is sufficiently satisfied when the cycle Tc of the image acquiring operation is 33 [ms] or less. Therefore, the sensor control signal CS can be used as a synchronization signal of the refresh signal REF without problems. And, by using the originally existing sensor control signal CS, an overhead of the circuit area accompanied by the generation of the refresh signal REF can be suppressed.

### Main Effects According to First Embodiment

As described above, in the first embodiment, the capacitor type hole amplifier circuit HAMP is provided. And, the hole amplifier circuit HAMP includes the refresh circuit REFC synchronizing with the sensor control signal CS and causing the differential input nodes NiP, NiN to retain the correction voltages Vp, Vn. Consequently, offset correction is performed without using the digital-to-analog converter. As a result, the semiconductor device DEV can be downsized. Further, the start-up test for determining the optimum correction voltages Vp, Vn, that is, the start-up sequence can be made unnecessary.

### Second Embodiment

### Details of Refresh Circuit

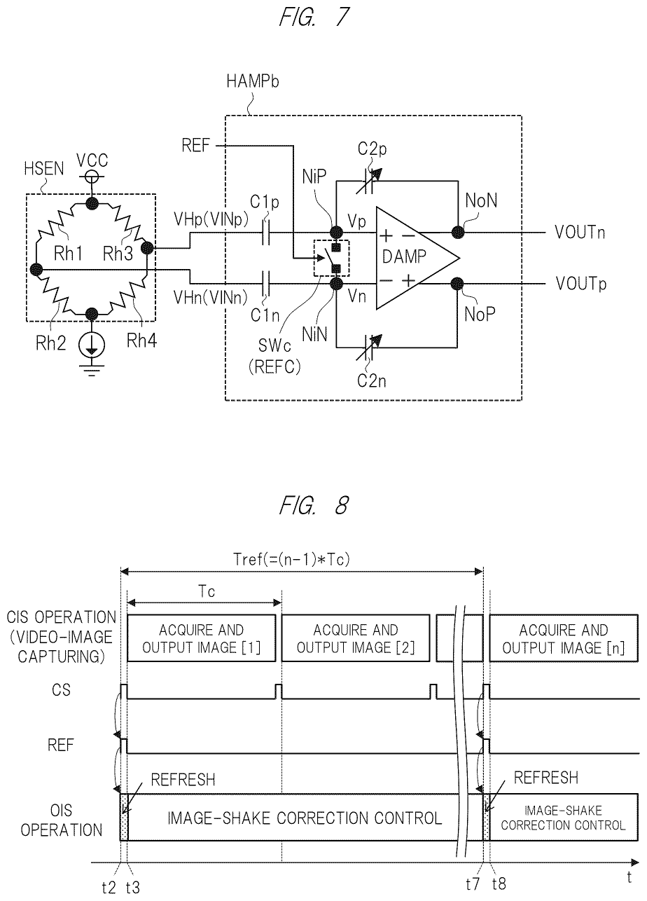

In a second embodiment, a refresh circuit REFC different from the case of FIG. 5 will be explained. FIG. 7 is a circuit diagram showing a configuration example of a hole amplifier circuit HAMPb while including the details of the refresh circuit REFC shown in FIG. 3 in a semiconductor device according to a second embodiment. The refresh circuit REFC shown in FIG. 7 includes a switch (second refresh switch) SWc causes short-circuit between the two differential input nodes NiP, NiN. The switch SWc is controlled to be in the on-state in the assertion period of the refresh signal REF, and is controlled to be in the off-state in the negation period. Note that the switch SWc can be made of, for example, a CMOS switch.

FIG. 8 is a timing chart showing one example of the operation sequence of the camera system shown in FIG. 1 and FIG. 7. FIG. 8 shows a period after time t2 in FIG. 4. In addition, in FIG. 8, the image acquiring operation has been performed n-th (“n” is integer equal to or larger than 3) times. In FIG. 8, the cycle Tref of the refreshing operation becomes longer than the case of FIG. 4. In this example, the cycle Tref of the refreshing operation becomes “(n−1)*Tc”.

For example, the control input interface CIF generates the refresh signal REF by thinning out the input sensor control signal CS. Specifically, the control input interface CIF generates the first refresh signal REF in accordance with the sensor control signal CS at time t2 to t3 for instructing the first image acquiring operation. Subsequently, the control input interface CIF generates the second refresh signal REF in accordance with the sensor control signal CS at time t7 to t8 for instructing the n-th image acquiring operation.

The OIS controller OISC causes the hole amplifier circuit HAMPb to perform the refreshing operation in accordance with the refresh signal REF at time t2 to t3. After time t3, the OIS controller OISC continuously performs the controlling operation of the image-shake correction until time t7. Then, the OIS controller OISC causes the hole amplifier circuit HAMPb to perform the refreshing operation again in accordance with the refresh signal REF at time t7 to t8. After time t7, the OIS controller OISC continuously performs the controlling operation of the image-shake correction again.

Here, the refresh circuit REFC shown in FIG. 7, that is, the switch SWc sets a differential voltage between the two differential input nodes NiP, NiN to zero [V] in the refresh period. Consequently, in the refresh period, the two differential input nodes NiP, NiN can retain the correction voltages Vp, Vn for canceling the offset voltage Voff included in the hole voltage VH. That is, the two differential input nodes NiP, NiN retain the correction voltages Vp, Vn satisfying “Vp−Vn=0 [V]”.

In this way, by setting both ends of the switch SWc to have the same potential in the refresh period, the leak current via the switch SWc which is in the off-state does not occur in the normal period after that. Therefore, as shown in FIG. 8, the cycle Tref of the refreshing operation can be further extended. For example, the cycle Tref can be set to several [seconds] or more. As a result, for example, the power consumption caused by the refreshing operation can be reduced.

Further, there is no problem for the handling even in specifications in which the sensor control signal CS is generated once for a plurality of times of the image acquiring operations. Note that the configuration example shown in FIG. 7 is different from the configuration example shown in FIG. 5 in that the offset voltages VOFp, VOFn equivalently occurring in the differential amplifier DAMP itself are not canceled. From this viewpoint, it becomes beneficial to use the configuration example shown in FIG. 5. However, generally, the offset voltages VOFp, VOFn of the differential amplifier DAMP itself are much smaller than the offset voltage Voff included in the hole voltage VH. Therefore, practically, there is no particularly problem even when the configuration example shown in FIG. 7 is used.

### Main Effects According to Second Embodiment

As described above, even by the application of the method according to the second embodiment, the same effects as various effects described in the first embodiment are obtained. Further, since the frequency of the refreshing operation is smaller than that in the method according to the first embodiment, the power consumption of the semiconductor device DEV can be reduced.

### Third Embodiment

### Details of Refresh Circuit

In a third embodiment, a form in which the differential-output type differential amplifier DAMP shown in FIG. 5 and FIG. 7 is replaced with a single-output type differential amplifier will be explained. For example, when the digital-to-analog converters DAC1, DAC2 as shown in FIG. 13 are provided, the differential-output type differential amplifier DAMP is required. On the other hand, when the configuration example shown in FIG. 5 and FIG. 7 is used, the digital-to-analog converters DAC1, DAC2 can be made unnecessary. Therefore, the single-output type differential amplifier may be used.

Specifically, in order to downsize the semiconductor device DEV, it is desirable to make a power supply terminal sharable between the digital-to-analog converts DAC1, DAC2 and the differential amplifier. In this case, noise from the digital-to-analog converts DAC1, DAC2 comes around the differential amplifier via a power supply wiring. Consequently, setting accuracy of the correction voltage can be decreased. Therefore, the differential-output type differential amplifier DAMP is required. The differential amplifier DAMP can remove the noise coming around via the power supply wiring as common mode noise. On the other hand, the configuration example shown in FIG. 5 and FIG. 7 does not cause such noise itself.

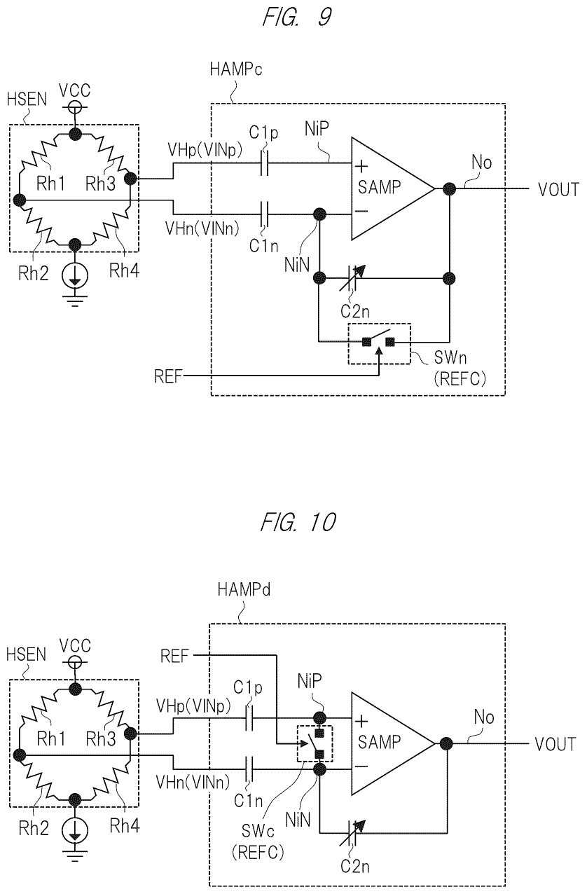

FIG. 9 is a circuit diagram showing a configuration example of a hole amplifier circuit HAMPc modified from that of FIG. 5, in a semiconductor device according to a third embodiment. In the hole amplifier circuit HAMPc shown in FIG. 9, the differential-output type differential amplifier DAMP shown in FIG. 5 is replaced with a single-output type differential amplifier SAMP. According to this, the inverting-side differential output node NoN of FIG. 5 and the capacitor C2p and the switch SWp connected to this are removed.

That is, the hole amplifier circuit HAMPc includes the differential amplifier SAMP having a single end output node “No”. In addition to this, the hole amplifier circuit HAMPc includes the same capacitor C1p, the same two capacitors C1n, C2n, and the same switch SWn as those of the case of FIG. 5. The switch (first refresh switch) SWn causes short-circuit between the output node No of the differential amplifier SAMP and one of the differential input nodes NiP, NiN in accordance with the refresh signal REF. More specifically, the switch SWn causes short-circuit between the output node No and the inverting-side differential input node NiN.

FIG. 10 is a circuit diagram showing a configuration example of a hole amplifier circuit HAMPd modified from that of FIG. 7, in the semiconductor device according to the third embodiment. In the hole amplifier circuit HAMPd shown in FIG. 10, the differential-output type differential amplifier DAMP shown in FIG. 7 is replaced with the single-output type differential amplifier SAMP. According to this, the inverting-side differential output node NoN in FIG. 7 and the capacitor C2p connected to this are removed.

That is, the hole amplifier circuit HAMPd includes the differential amplifier SAMP having the single end output node No. In addition to this, the hole amplifier circuit HAMPd includes the same capacitor C1p, the same two capacitors C1n, C2n, and the same switch SWc as those of the case of FIG. 7. The switch (second refresh switch) SWc causes short-circuit between the differential input nodes NiP, NiN in accordance with the refresh signal REF.

By using the configuration example shown in FIG. 9 or FIG. 10, the circuit area can be further reduced in comparison with the case of using the configuration example shown in FIG. 5 or FIG. 7. That is, the semiconductor device DEV can be further downsized and reduced in cost. More specifically, note that a power supply terminal can be made sharable between the differential amplifier SAMP and the analog-to-digital converter ADC provided at its subsequent stage. Therefore, the differential amplifier SAMP needs to allow the noise coming around via the power supply terminal to some extent. If the high accuracy to an extent not allowing this noise is required for the hole amplifier circuit HAMP, the differential-output type differential amplifier DAMP may be used.

### Main Effects According to Third Embodiment

As described above, even by the application of the method according to the third embodiment, the same effects as the various effects described in the first embodiment or the second embodiment are obtained. Further, by making the differential amplifier single-ended, the semiconductor device DEV can be further downsized in comparison with the method of the first embodiment or the second embodiment.

### Fourth Embodiment

### Details of Hole Amplifier Circuit

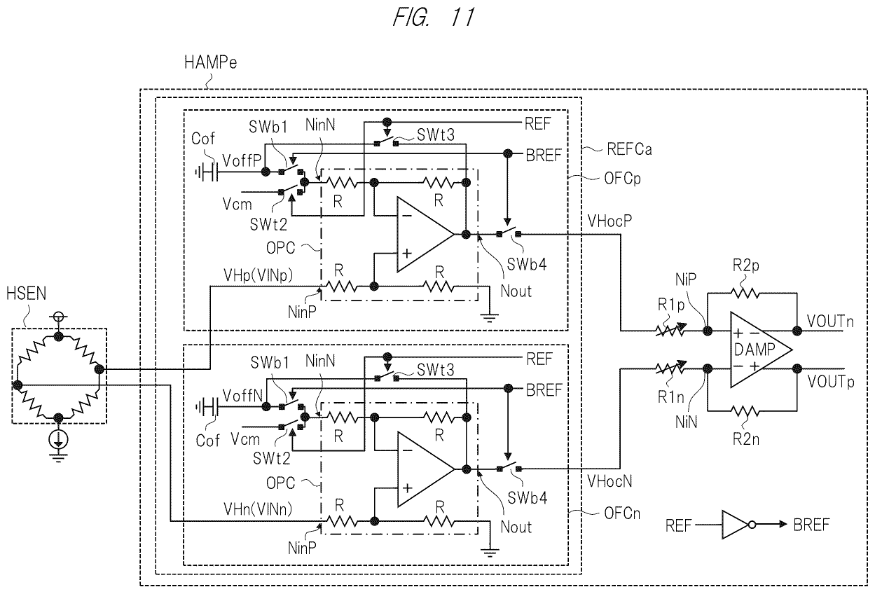

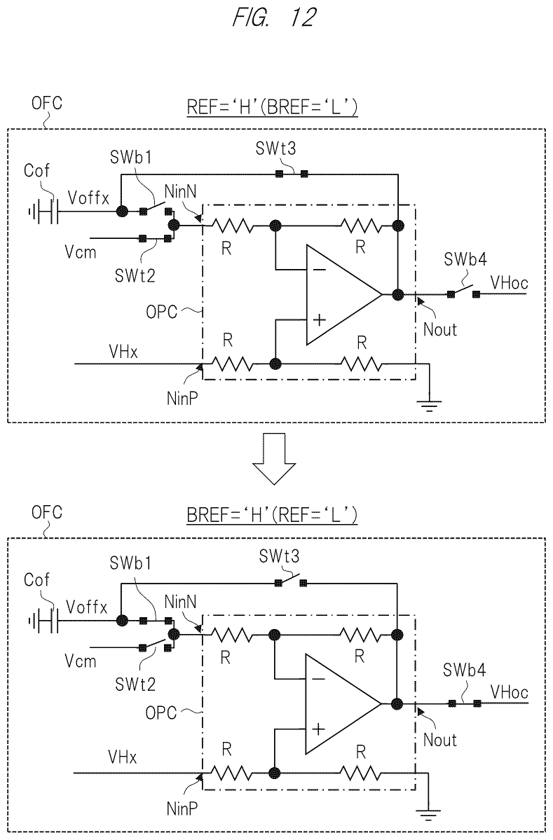

In a fourth embodiment, a form in which the digital-to-analog converter is not used while a resistance-element type hole amplifier circuit shown in FIG. 13 is used will be explained. FIG. 11 is a circuit diagram showing a configuration example of the hole amplifier circuit HAPM shown in FIG. 1 in a semiconductor device according to a fourth embodiment. FIG. 12 is a schematic diagram showing an operation example of an offset cancellation circuit OFC of FIG. 11.

A hole amplifier circuit HAMPe shown in FIG. 11 includes the same differential amplifier DAMP and the same resistance elements R1p, R2p, R1n, R2n as those of a case of FIG. 13. One ends of the resistance elements R1p, R2p, R1n, R2n are connected to the differential input nodes NiP, NiN to determine a gain of the hole amplifier circuit HAMPe. More specifically, in an assumption that a resistance value of the two resistance elements R1p, R1n is “R1” while a resistance value of the remaining two resistance elements R2p, R2n is “R2”, the gain is determined to be “R2/R1”. Note that the two resistance elements R1p, R1n are specifically made of a variable resistance element.

Further, the hole amplifier circuit HAMPe includes a refresh circuit REFCa. The refresh circuit REFCa is slightly different from the case of FIG. 3 in that the offset voltage Voff included in the hole voltage VH is acquired and retained in synchronization with the sensor control signal CS. And, the refresh circuit REFCa removes the retained offset voltage Voff from the hole voltage VH, and then, outputs it toward the differential input nodes NiP, NiN.

More specifically, the refresh circuit REFCa includes two offset cancellation circuits OFCp, OFCn. The offset cancelation circuit OFCp is inserted into a path used for input of the positive-side hole voltage VHp to the non-inverting-side differential input node NiP. The offset cancellation circuit OFCn is inserted into a path used for input of the negative-side hole voltage VHn to the inverting-side differential input node NiN. The two offset cancellation circuits OFCp, OFCn both have the same configuration. In the specification, the two offset cancellation circuits OFCp, OFCn are called an offset cancellation circuit OFC as a generic term.

The offset cancellation circuit OFC includes an operational amplifier OPC, four switches SWb1, SWt2, SWt3, SWb4, and a capacitor Cof. The operational amplifier OPC includes an inverting input node NinN, a non-inverting input node NinP, and an output node Nout. The operational amplifier OPC is made of a general differential amplifier circuit made of a differential amplifier and four resistance elements. The operational amplifier OPC is set to have the gain of one times by the four resistance elements having the same resistance value.

The switch (first switch) SWb1 and the capacitor Cof are connected in series between the inverting input node NinN and a power supply node such as a ground power supply node. The switch (second switch) SWt2 connects a reference voltage node to which the reference voltage Vcm is applied, to the inverting input node NinN. The switch (third switch) SWt3 connects the output node Nout to the capacitor Cof. The switch (fourth switch) SWb4 connects the output node Nout to one of the differential input nodes NiP, NiN.

More specifically, the switch SWb4 in the offset cancellation circuit OFCp connects the output node Nout to the non-inverting-side differential input node NiP. The switch SWb4 in the offset cancellation circuit OFCn connects the output node Nout to the inverting-side differential input node NiN. In addition, in the offset cancellation circuit OFCp, the positive-side hole voltage VHp is input to the non-inverting input node NinP included in the operational amplifier OPC. In the offset cancellation circuit OFCn, the negative-side hole voltage VHn is input to the non-inverting input node NinP included in the operational amplifier OPC.

Here, the two switches SWt2, SWt3 are controlled to be in the on-states in the assertion period of the refresh signal REF. That is, the two switches SWt2, SWt3 synchronize with the sensor control signal CS, and both are controlled to be in the on-states in a fixed period. Meanwhile, both the remaining two switches SWb1, SWb4 are controlled to be in the on-states and the off-states complementarily with the two switches SWt2, SWt3. That is, the remaining two switches SWb1, SWb4 are controlled to be in the on-states in an assertion period of an inverting refresh signal BREF that is an inverting signal of the refresh signal REF.

FIG. 12 shows an operation in the assertion period of the refresh signal REF, that is, in a “H” level period, and an operation in the assertion period of the inverting refresh signal BREF. In the “H” level of the refresh signal REF, that is, in the refresh period, the two switches SWt2, SWt3 among the four switches are controlled to be in the on-states. In this case, the operational amplifier OPC outputs a differential voltage between a hole voltage VHx at the non-inverting input node NinP and a reference voltage Vcm at the inverting input node NinN. This differential voltage “VHx−Vcm” is applied as an offset voltage Voffx to the capacitor Cof via the switch SWt3.

As a result, as shown in FIG. 11, the capacitor Cof in the offset cancellation circuit OFCp retains the offset voltage VoffP. The offset voltage VoffP is a differential voltage “VHp−Vcm” between the positive-side hole voltage VHp and the reference voltage Vcm. Similarly, the capacitor Cof in the offset cancellation circuit OFCn retains the offset voltage VoffN. The offset voltage VoffN is a differential voltage “VHn−Vcm” between the negative-side hole voltage VHn and the reference voltage Vcm.

Meanwhile, in FIG. 12, in the “H” level period of the inverting refresh signal BREF, that is, in the normal period, the two switches SWb1, SWb4 among the four switches are controlled to be in the on-states. In this case, the operational amplifier circuit OPC outputs a differential voltage between the hole voltage VHx at the non-inverting input node NinP and the offset voltage Voffx at the inverting input node NinN.

As described above, in the refresh period, the offset cancellation circuit OFC acquires and retains the offset voltage Voffx. And, in the normal period, the offset cancellation circuit OFC subtracts the retained offset voltage Voffx from the hole voltage VHx, and outputs it. Consequently, the offset cancellation circuit OFC can output a hole voltage VHoc from which the offset voltage Voffx is canceled, that is, removed.

That is, as shown in FIG. 11, the offset cancellation circuit OFCp can output a hole voltage VHocP from which the offset voltage VoffP is removed, toward the non-inverting-side differential input node NiP. Similarly, the offset cancellation circuit OFCn can output a hole voltage VHocN from which the offset voltage VoffN is removed, toward the inverting-side differential input node NiN.

### Main Effects According to Fourth Embodiment

As described above, even by the application of the method according to the fourth embodiment, the offset correction is performed without using the digital-to-analog converter similarly to the case of the first embodiment. As a result, the semiconductor device DEV can be downsized. That is, the refresh circuit REFCa shown in FIG. 11 can be generally made with a smaller area than those of the digital-to-analog converters DAC1, DAC2 shown in FIG. 13. In addition, since the digital-to-analog converters DAC1, DAC2 are unnecessary, the start-up test that is the start-up sequence as described in FIG. 15 can be also made unnecessary.

In the foregoing, the invention made by the inventors of the present application has been concretely described based on the embodiments. However, the present invention is not limited to the foregoing embodiments, and various modifications and alterations can be made within the scope of the present invention. For example, the above-described embodiments have been explained in detail for making the present invention understandable, and are not always limited to the one including all structures explained above. Also, a part of the structure of one embodiment can be replaced with the structure of another embodiment, and besides, the structure of another embodiment can be added to the structure of one embodiment. Further, another structure can be added to/eliminated from/replaced with a part of the structure of each embodiment.

What is claimed is:

1. A semiconductor device comprising:
an amplifier circuit amplifying a differential detection signal from a predetermined sensor to have a predetermined gain; and
a first input terminal to which a sensor control signal generated in a period in which an image acquiring operation by an image sensor is not performed is input,
wherein the amplifier circuit includes:
a differential amplifier including a differential input node for input of the differential detection signal;
a plurality of capacitors, one end of which is connected to the differential input node to determine the predetermined gain; and
a refresh circuit synchronizing with the sensor control signal, and causing the differential input node to retain a correction voltage for canceling an offset voltage included in the differential detection signal.

2. The semiconductor device according to claim 1,
wherein the predetermined sensor is a hole sensor detecting a position of an optical image stabilization (OIS) lens.

3. The semiconductor device according to claim 2, further comprising:
an analog-to-digital converter converting an output voltage of the amplifier circuit into a digital value;
a second input terminal to which a detection signal from a motion sensor is input; and
a processor calculating an operation amount in moving the position of the OIS lens, based on the detection signal from the motion sensor and the digital value from the analog-to-digital converter.

4. The semiconductor device according to claim 1,
wherein the sensor control signal is a signal for instructing the image sensor to start the image acquiring operation.

5. The semiconductor device according to claim 1,
wherein the refresh circuit includes a first refresh switch synchronizing with the sensor control signal and causing short-circuit between an output node of the differential amplifier and at least one of two nodes of the differential input node.

6. The semiconductor device according to claim 5,
wherein the differential amplifier includes a differential output node, and
wherein the first refresh switch is made of two switches causing short-circuit between the differential output node and the differential input nod.

7. The semiconductor device according to claim 1,
wherein the refresh circuit includes a second refresh switch synchronizing with the sensor control signal, and causing short-circuit between the differential input nodes.

8. A semiconductor device comprising:
an amplifier circuit amplifying a differential detection signal from a predetermined sensor to have a predetermined gain; and
a first input terminal to which a sensor control signal generated in a period in which an image acquiring operation by an image sensor is not performed is input,
wherein the amplifier circuit includes:
a differential amplifier including a differential input node for input of the differential detection signal;
a plurality of resistance elements, one end of which is connected to the differential input node to determine the predetermined gain; and
a refresh circuit synchronizing with the sensor control signal, acquiring and retaining an offset voltage included in the differential detection signal, removing the retained offset voltage from the differential detection signal, and then outputting a resultant signal toward the differential input node,
wherein the refresh circuit includes two offset cancellation circuits each inserted into a path for input of the differential detection signal to two nodes configurating the differential input node,
wherein each of the two offset cancellation circuits includes:
an operational amplifier circuit including an inverting input node, a non-inverting input node, and an output node, and set to have a gain of one times by a resistance element;
a first switch and a capacitor connected in series between the inverting input node and a power supply node;
a second switch connecting a reference voltage node, to which a reference voltage is applied, to the inverting input node;
a third switch connecting the output node to the capacitor; and
a fourth switch connecting the output node to one of the two nodes configurating the differential input node,
wherein the second switch and the third switch synchronize with the sensor control signal, and are both controlled to be in on-states in a fixed period,
wherein both of the first switch and the fourth switch are controlled to be in on-states and off-states complementarily with the second switch and the third switch, and
wherein one of two signals configurating the differential detection signal is input to the non-inverting input node.

9. The semiconductor device according to claim 8,
wherein the predetermined sensor is a hole sensor detecting a position of an optical image stabilization (OSI) lens.

10. The semiconductor device according to claim 9, further comprising:
an analog-to-digital converter converting an output voltage of the amplifier circuit into a digital value;
a second input terminal to which a detection signal from a motion sensor is input; and
a processor calculating an operation amount in moving the position of the OIS lens, based on the detection signal from the motion sensor and the digital value from the analog-to-digital converter.

11. A camera system mounted in one casing, comprising:
an image sensor acquiring an image;
an optical image Stabilization (OIS) lens movably installed with respect to the image sensor, and collecting light from a light source onto the image sensor;
a position sensor detecting a position of the OIS lens;
an image sensor controller controlling the image sensor; and
an OIS controller controlling the position of the OIS lens, based on a detection result of the position sensor and a detection result of the motion sensor,
wherein the OIS controller includes:
an amplifier circuit amplifying a differential detection signal from the position sensor to have a predetermined gain; and
a first input terminal to which a sensor control signal generated in a period in which an image acquiring operation by the image sensor is not performed is input, and
wherein the amplifier circuit includes:
a differential amplifier including a differential input node for input of the differential detection signal;
a plurality of capacitors, one end of which is connected to the differential input node to determine the predetermined gain; and
a refresh circuit synchronizing with the sensor control signal, and causing the differential input node to retain a correction voltage for canceling an offset voltage included in the differential detection signal.

12. The camera system according to claim 11,
wherein the position sensor is a hole sensor.

13. The camera system according to claim 12,
wherein the OIS controller further includes:
an analog-to-digital converter converting an output voltage of the amplifier circuit into a digital value;
a second input terminal to which a detection signal from the motion sensor is input; and
a processor calculating an operation amount in moving the position of the OIS lens, based on the detection signal from the motion sensor and the digital value from the analog-to-digital converter.

14. The camera system according to claim 11,
wherein, in a refresh period in which the correction voltage is retained by the differential input node, the OIS controller performs control so as to maintain the position of the OIS lens positioned at a start time point of the refresh period, as it is.
